(19) United States
(12) Patent Application Publication
(10) Pub. No.: US 2002/0185352 A1
(43) Pub. Date: Dec. 12, 2002

(54) Starter device for an internal combustion engine

(75) Inventor: Markus Husges, Gmund (DE)

Correspondence Address: ROBERT W. BECKER & ASSOCIATES, Suite B, 707 Hwy 66 East, Tijeras, NM, 87059, US

(73) Assignee: Markus Husges to Andreas Stihl AG & Co., Waiblingen (DE)

(21) Appl. No.: 10/159,876

(22) Filed: May 30, 2002

(30) Foreign Application Priority Data
Jun. 11, 2001 (DE) 201 09 743.5

(51) Int. Cl. F02N 3/02

(52) U.S. Cl. 192/42; 192/46; 74/6

(57) ABSTRACT

A rope pull starter device for an internal combustion engine in a motor-driven, manually guided implement is provided, and has a clutch drum and a power transfer member on the clutch drum. Connected with the clutch drum is a carrier for a locking mechanism for the transfer of a drive torque from the clutch drum to a motor shaft of the internal combustion engine. Provided on the carrier is a pivotable pawl for the reversible engagement in a clutch element, whereby the pawl is provided with a pawl pin for the pivotable control of the pawl with the aid of a guide clip that rests against the pawl pin. The pawl pin is made of a different material than is the pawl.

### BACKGROUND OF THE INVENTION

The present invention relates to a starter device for an internal combustion engine, especially a rope pull starter device for a motor-driven, manually guided implement.

Starter devices for internal combustion engines are known, whereby a rope pull activated coupling or clutch drum is provided with a power transfer member that acts upon a carrier of a locking mechanism. The ratchet or locking mechanism serves for the reversible engagement in a clutch element on a motor shaft of the internal combustion engine, and for the rotatable connection of the clutch drum with the motor shaft. One or more pivotable pawls of the locking mechanism are pivoted during a starting process with the aid of a sliding block type guide means comprised of a pawl pin on the pawl, and a guide element that is embodied as a guide clip; this causes the pawls to come into engagement with teeth of the clutch element, thereby causing the motor shaft to be rotated.

The pawls and the pawl pins are made of a thermoplastic polymeric material. After the internal combustion engine has operated for a number of hours, wear occurs between the guide clip and the pawl pins, which can lead to failure of the pawl pins.

It is therefore an object of the present invention to improve a starter device for an internal combustion engine in such a way that a longer operating time can be achieved without damage to the pawl pins.

### BRIEF DESCRIPTION OF THE DRAWINGS

This object, and other objects and advantages of the present invention, will appear more clearly from the following specification in conjunction with the accompanying schematic drawings, in which:

FIG. 1 is an exploded view of one exemplary embodiment of an inventive starter device;

FIG. 2 shows the clutch drum of the starter device of FIG. 1 with a locking mechanism;

FIG. 3 is a cross-sectional view taken through the clutch drum along the line III-III in FIG. 2; and

FIG. 4 is a longitudinal cross-sectional view through a pawl with a pawl pin of the starter device of FIG. 1.

### SUMMARY OF THE INVENTION

The starter device of the present invention is characterized primarily in that the pawl pin is made of a different material than is the pawl, whereby the material of the pawl pin is selected such that it forms a wear-resistant, durable friction pairing with the material of the guide element or guide clip that rests against it. This reduces the wear not only on the guide clip but also on the pawl pin. Disruptions in operation of the starting device due to failure of the pawl pin or of the guide clip are thereby prevented.

The pawl pin can be formed not only of metallic material but also of non-metallic material. The material from which the pawl pin is formed can be the same material as that of the guide clip. It is expedient to make the pawl pin of a wear-resistant polymeric material or of metal, preferably of steel. The pawl pin preferably has a cylindrical shape and, for its axial anchoring in the main body of the pawl, is provided with an undercut, preferably a radial undercut. In the installed state of the pawl pin, the undercut is disposed within the pawl. In this connection, the undercut is expediently embodied as a circumferential groove on the pawl pin. The pawl is expediently formed of partially crystalline, aliphatic polyamides or semi aromatic, especially semi aromatic/cyclical, polyamides. Polyoxymethylenes are also suitable as the material for the pawl due to their good sliding and wear characteristics. The pawl is preferably produced as an injection molded part in an injection molding process, whereby the pawl pin, which is previously positioned in the appropriate injection mold, is embedded in polymeric material.

It can also be expedient to press the pawl pin into the pawl after the manufacture of the pawl, or to tightly, positively and/or frictionally connect the pawl pin with the pawl in some other fashion, such as, for example, by riveting, bolting, fusing, or the like. It is expedient to guide the pawl pin approximately parallel to a pivot axis of the pawl on the carrier, and to allow the pawl pin to project out of the pawl.

Further specific features of the present invention will be described in detail subsequently.

### DESCRIPTION OF PREFERRED EMBODIMENTS

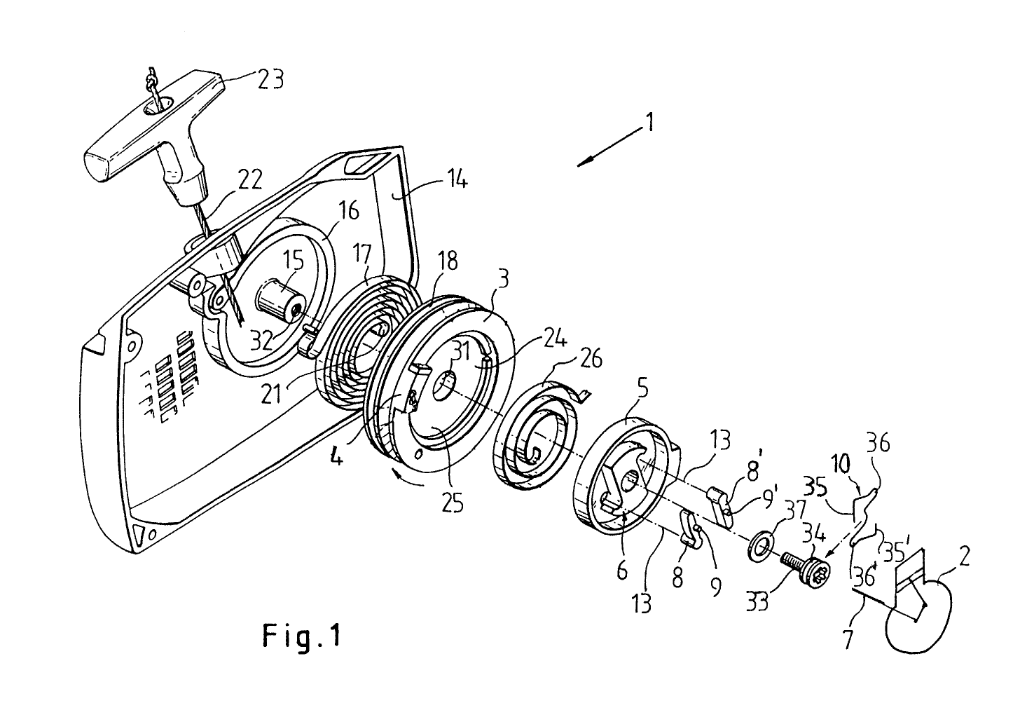

Referring now to the drawings in detail, FIG. 1 shows a starter device for the manual start-up of an internal combustion engine, for example for a motor-driven, manually guided implement, such as a power chainsaw. The starter device is accommodated in a housing 14, which in the illustrated embodiment is shown as a cover of a motor housing of a power chainsaw. Projecting from the inner wall of the housing 14 is a journal pin 15 that is surrounded by a spring housing 16 that is integral with the housing 14. Disposed in the spring housing 16 is a spiral spring 17, which is fixed at one end to the rim of the housing. The spiral spring 17 is covered by a metal disc or pulley 18 and serves as a restoring spring for a rope drum type coupling or clutch drum 3, which is provided with a power transfer member 4. On its backside, the clutch drum 3 has a journal 19 (see FIG. 3) that faces the spiral spring 17 and extends into the spring housing 16. The journal 19 has an axial slot 20 for engagement of the inner end 21 of the spiral spring 17. Wound upon the clutch drum 3 is a cable or rope 22, the free end of which extends out of the housing 14, with a handle 23 being secured to the free end thereof. By pulling the rope 22 via the handle 23, the clutch drum 3 is rotated about the journal pin 15.

The clutch drum 3 has a circular receiving chamber 24 that surrounds the journal pin 15 for a cup-shaped carrier 5 of a ratchet or locking mechanism 6, which is provided with two detents or pawls 8, 8′ that are pivotably mounted in the carrier 5. Disposed between the carrier 5 and that end wall 25 of the clutch drum 3 that delimits the receiving chamber 24 is an elastically deformable follower member 26, which is embodied as a spiral spring. With the aid of the follower member 26, fluctuations of the torque that is to be applied to the motor shaft 7 of the internal combustion engine 2 are compensated for. The carrier 5 is mounted on the journal pin 15 (see FIG. 1). The clutch drum 3 is mounted on the carrier 5, whereby an end face of the shoulder 27 of the clutch drum 3 (see FIG. 3), relative to its cross-sectional contour, forms a sliding surface. The carrier 5 has a centrally disposed carrier step 28 that is spirally formed on the periphery and is directed from the base 29 of the carrier 5 toward the end wall 25 of the clutch drum 3. Disposed on the base 29 of the carrier 5 is a support element 30 of the locking mechanism 6, which support element is monolithically formed with the carrier 5. In this support element 30, the two pawls 8, 8′, via widened portions, are pivotably inserted about respective pivot axes 13. Each of the pawls 8, 8′ carries a pin 9, 9′, which projects outwardly counter to the direction of extension of the widened portions.

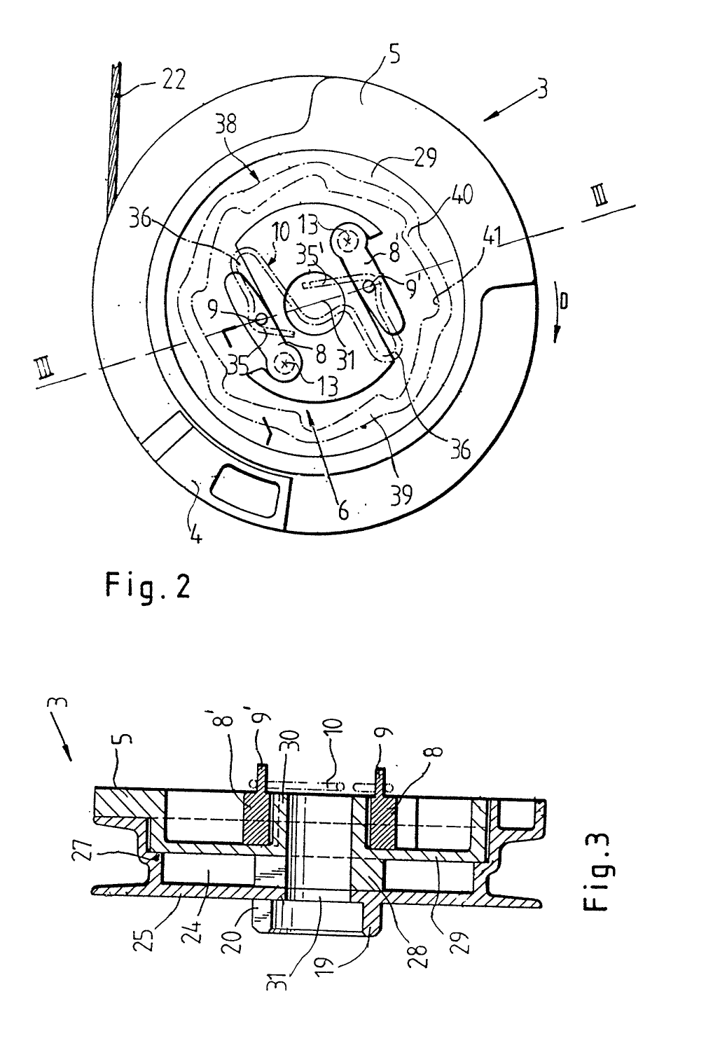

In the assembled state of the starter device, the journal pin 15, which is fixed on the housing, passes through a central bore 31 of the end wall 25 of the clutch drum 3, and through the carrier 5, the carrier step 28 of which, and the support element 30, form a sleeve-like receiving means for the journal pin 15. Screwed into an axial thread 32 of the journal pin 15 is a threaded bolt 33, in the head of which is provided an annular groove 34 (see FIG. 1). Inserted into this annular groove 34 is a guide clip 10, which is made of spring steel wire; the two free legs 35, 35′ of the guide clip each extend about one of the two pawl pins 9, 9′ in the position of rest of the clutch drum 3 (see FIG. 2), whereby the end of the free leg 35′, as does the central portion of the guide clip 10, rests in the annular groove 34. The guide clip 10 has respective, hairpin-shaped bends 36, 36′ in which the pertaining pawl pins 9, 9′ rest. Disposed between the guide clip 10 and the support element 30 of the locking mechanism 6 is a washer 37 that surrounds the head of the threaded bolt 33. The washer 37 ensures an undisturbed relative rotation between the guide clip 10 and the support element 30.

The rotational movement of the clutch drum 3 is transferred to a coupling or clutch element 38 that is fixedly connected with the motor shaft 7 that is to be driven. In the embodiment illustrated in FIG. 2, the clutch element 38 is a clutch can 39 that is monolithically formed with a fan wheel that is fixedly seated on the motor shaft 7. The inner wall of the clutch can 39 is provided with a toothing 40 with which, after mounting of the starter device, the clutch can 39 engages in the cup-shaped carrier 5.

If the clutch drum 3 is rotated by pulling the rope 22, it takes along the carrier 5 of the locking mechanism 6 by means of the follower or driver member 26. In so doing, the support element 30 of the locking mechanism 6 rotates about the journal pin 15, while the guide clip 10 initially maintains its position, since it is frictionally connected with the threaded bolt 33, and hence with the journal pin 15. The pins 9, 9′ of the two pawls 8, 8′ thereby migrate in the bends 36, 36′ outwardly in a direction toward the ends of the bends, as a result of which the pawls 8, 8′ pivot outwardly. In this radially outwardly pivoted position, the pawls 8, 8′ take the guide clip 10 along with them, with the guide clip then rotating against the frictional resistance in the annular groove 34 of the threaded bolt 33 about the axis of the journal pin 15. During the further rotation of the clutch drum 3, and hence of the locking mechanism 6, in the direction of the arrow D (see FIG. 2), the pawls 8, 8′ remain in their pivoted-out position and thereby each engage in a tooth base 41 of the toothing 40. As a consequence, the clutch can 39, and hence the motor shaft 7 that is to be driven, are rotated. If the internal combustion engine 2 is started up and reaches a prescribed speed, the toothing 40 of the clutch can 39 overtakes the locking mechanism 6, whereby the pawls 8, 8′ are pivoted back.

To avoid wear during engagement of the pawls 8, 8′ in the toothing 40 of the clutch can 39, such toothing is preferably made of the same material as the pawls 8, 8′, for example of thermoplastic polymeric material such as polyoxymethylene or polyamide. In contrast, the guide clip 10 is made of a metallic material, preferably spring steel. The pawl pins and the guide clip are advantageously made of materials that produce a wear-resistant friction pairing. In the illustrated embodiment, the pawl pins 9, 9′ are made of a different material than are the pawls 8, for example of metal, and preferably of a wear-resistant steel alloy. However, it can also be expedient to make the pawl pins 9, 9′ of a wear-resistant polymeric material or of some other material.

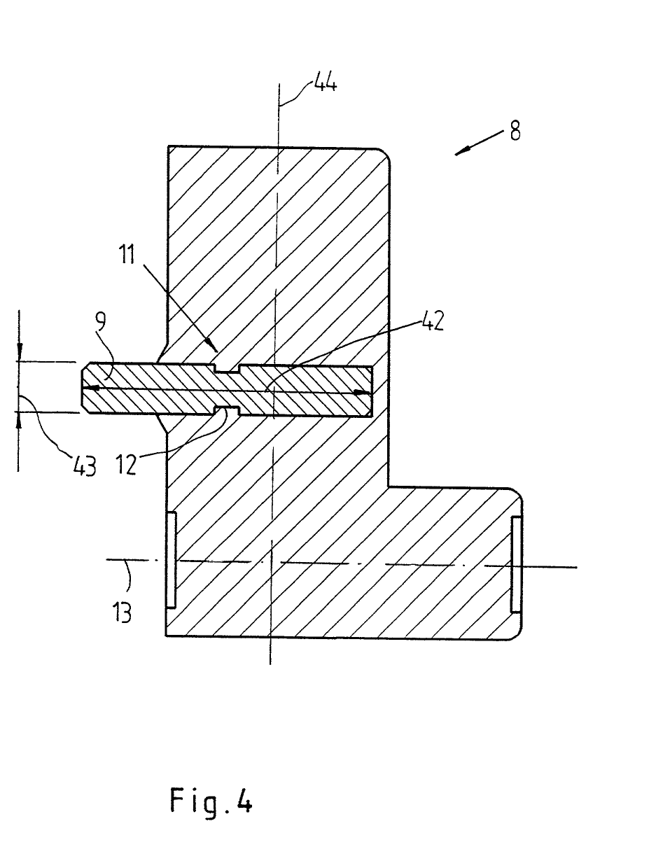

As shown in FIGS. 1 and 4, in the illustrated embodiment the pawl pins 9, 9′ are formed as an elongated, cylindrical component, with approximately ⅔ of its axial length being disposed in the material of the pawls 8, 8′, while approximately ⅓ of its axial length projects out of the main body of the respective pawl 8, 8′. In this connection, the axial length 42 of the pawl pins 9, 9′ corresponds approximately to seven times its diameter 43. To secure the pawl pins 9, 9′ against axial displacement in the pawls 8, 8′, each of the pins is provided with an undercut 11 that in the illustrated embodiment is embodied as a circumferential groove 12. In the illustrated embodiment, the pawls 8, 8′ are formed as injection molded parts, whereby the pawl pins are preferably introduced prior to the injection molding process for the manufacture of the pawls in appropriate molds, and are embedded in polymeric material. However, it can also be expedient to press the pawl pins 9, 9′ in with the aid of a pressing process after the manufacture of the pawls 8, 8′, or to positively, tightly or frictionally secure the pins in the pawls in some other suitable manner. The longitudinal axis 44 of a respective pawl 8, 8′ passes through the pin at approximately half the height of the pawl, and in the illustrated embodiment extends perpendicular to a pivot axis 13 about which the bearing-like widened portion of the pawl is pivotably held on the carrier 5. As shown in FIG. 1, in cross-section the pawls 8, 8′ have an essentially elliptical or semi elliptical shape, while in plan they have a rectangular configuration.

The specification incorporates by reference the disclosure of German priority document 201 09 743.5 of Jun. 11 2001.

The present invention is, of course, in no way restricted to the specific disclosure of the specification and drawings, but also encompasses any modifications within the scope of the appended claims.

We claim:

1. A starter device for an internal combustion engine, comprising:
a clutch drum, which is provided with a power transfer member;
a carrier for a locking mechanism for transfer of drive torque from said clutch drum to a motor shaft of said internal combustion engine, wherein said carrier is rotatably connected with said clutch drum; and
a pivotable pawl disposed on said carrier for a reversible engagement in a clutch element of said motor shaft, wherein said pawl is provided with a pawl pin for a pivotable control of said pawl with the aid of a guide clip that rests against said pawl pin, and wherein said pawl pin is made of a different material than is said pawl.

2. A starter device according to claim 1, wherein said pawl pin and said guide clip are formed of materials that form a wear-resistant friction pairing.

3. A starter device according to claim 2, wherein said pawl pin is formed of a wear-resistant polymeric material.

4. A starter device according to claim 1, wherein at least one of said pawl pin and said guide clip is made of metal.

5. A starter device according to claim 4, wherein said metal is steel.

6. A starter device according to claim 1, wherein said pawl pin is an essentially cylindrical component.

7. A starter device according to claim 1, wherein said pawl pin is provided with an undercut that is disposed in the material of said pawl.

8. A starter device according to claim 7, wherein said undercut is formed by a circumferential groove.

9. A starter device according to claim 1, wherein said pawl is formed of polymeric material.

10. A starter device according to claim 9, wherein said polymeric material is polyoxymethylene or polyamide.

11. A starter device according to claim 9, wherein said pawl is an injection molded part, and said pawl pin is embedded in polymeric material.

12. A starter device according to claim 1, wherein said pawl pin is pressed into said pawl.

13. A starter device according to claim 1, wherein said pawl is pivotable on said carrier about a pivot axis, and wherein said pawl pin is guided approximately parallel to said pivot axis.
